(19) United States
(12) Patent Application Publication
(10) Pub. No.: US 2006/0250647 A1
(43) Pub. Date: Nov. 9, 2006

(54) Method and apparatus of generating files for playing back

(75) Inventors: Yao-Chang Huang, Taoyuan (TW); Chang-Hung Lee, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/417,566

(22) Filed: May 3, 2006

(30) Foreign Application Priority Data
May 4, 2005 (TW) 094114333

(51) Int. Cl. G06F 3/12

(52) U.S. Cl. 358/1.15; 358/1.13

(57) ABSTRACT

An apparatus for processing an input file is provided. The apparatus includes a transforming module, a combining module, and a transmitting module. The transforming module transforms the input file into an output file in a VOB (video object) format. The combining module first generates an information file corresponding to the output file and then combines the output file with the information file to generate a combined file. The transmitting module is used for transmitting the combined file generated by the combining module.

### BACKGROUND OF THE INVENTION

1. Field of the Invention

This invention is related to an apparatus and a method for transforming the format of a file. More specifically, this invention relates to an apparatus and a method for transforming the format of a multimedia file.

2. Description of the Prior Art

In the present day, multimedia storage systems and multimedia displaying systems have not been integrated together in most families. When a user wants to transmit a multimedia file stored in the disk of a computer to a TV and to display the multimedia file on the TV, two methods can be used. The first method is first burning the multimedia file on an optical storage medium, and then reads the multimedia file by a display system capable of accessing the multimedia file stored in the optical storage medium. This method not only wastes hardware resources but also is inconvenient for users. The second method previously sets a network between the disk drives of a computer and a TV display system. In the second method, users can access multimedia files from the disk drives through the network at the side of TV display system. However, there are a variety of formats of multimedia files. The applications for opening multimedia files in different formats are also different. A multimedia file to be played back might be a video file in .mpeg, .wmv, .asf, or .avi format, an audio file in .wav, .cda, .wma, .mid, or .mp3 format, or even a picture in .jpeg, .gif, .bmp, .tiff, or .png format. In this way, users must install lots of applications, for instance, software for processing video files, audio files, and pictures, in the TV display system. The advantage of the second method is that lots of applications must be installed. Different user interfaces of the applications also torment most users.

This invention provides an apparatus and a method for transforming the format of a file. The apparatus and method according to this invention first transforms the multimedia files into files conforming to the DVD format at the side of storage systems, and then transmits the transformed file to a display system through wired or wireless networks. Since a file conforming to the DVD format has a clear and convenient displaying menu, it is much easier for users to watch and control the transformed file displayed at display systems; thus, aforementioned problems can be solved.

### SUMMARY OF THE INVENTION

The main purpose of this invention is providing an apparatus and a method for transforming the format of a multimedia file.

The transforming apparatus according to one preferred embodiment of this invention includes a transforming module, a combining module, and a transmitting module. The transforming module transforms an input file into an output file in a VOB (video object) format. The combining module generates an information file corresponding to the output file and combines the output file with the information file to generate a combined file. The transmitting module is used for transmitting the combined file.

Besides a transforming module, a combining module, and a transmitting module, the other preferred embodiment of this invention further includes a receiving module and a playing back module. The receiving module is used for receiving the combined file and the playing back module is used for playing back the combined file.

The advantage and spirit of the invention may be understood by the following recitations together with the appended drawings.

### BRIEF DESCRIPTION OF THE APPENDED DRAWINGS

FIG. 1 shows the flowchart of the processing method according to the third preferred embodiment of this invention.

FIG. 2 shows the block diagram of the processing system according to the fourth preferred embodiment of this invention.

### DETAILED DESCRIPTION OF THE INVENTION

The main purpose of this invention is providing an apparatus and a method for transforming the format of a multimedia file. Before transmitting and displaying multimedia files, the apparatus and method according to this invention first transforms the multimedia files into files conforming to DVD format at the side of storage systems.

A file in a DVD format includes three kinds of sub-files: .VOB, .IFO, and .BUP. All the images, audios, and subtitles are stored in the .VOB sub-file. The .IFO sub-file is used for storing a variety of information about the .VOB sub-file, for example, which subtitles, languages, and angles are included in the .VOB sub-file, and the positions of each kind of data in the .VOB sub-file. The .BUP sub-file is the backup of the .IFO sub-file.

The transforming apparatus according to the first preferred embodiment of this invention includes a transforming module, a combining module, and a transmitting module. The transforming module transforms an input file into an output file in a VOB format. The combining module generates an information file corresponding to the output file and combines the output file with the information file to generate a combined file. The transmitting module is used for transmitting the combined file. The output file may include a plurality of sections and the information file can be relative to the positions and relations of each section in the output file. That is to say, the information file can include index information of the output file such that users can find each section rapidly. Actually, the information file generated by the combining module includes the .IFO file and the .BUP file corresponding to the output file in the VOB format. When the combined file is played back, the information file is used for providing the displaying menu of the multimedia file.

In actual applications, the input file can be any kind of multimedia file, for instance, a video file in .mpeg, .wmv, .asf, or .avi format, an audio file in .wav, .cda, .wma, .mid, or .mp3 format, or even a picture in .jpeg, .gif, .bmp, .tiff, or .png format.

Besides a transforming module, a combining module, and a transmitting module, the other preferred embodiment of this invention further includes a receiving module and a playing back module. The receiving module is used for receiving the combined file and the playing back module is used for playing back the combined file.

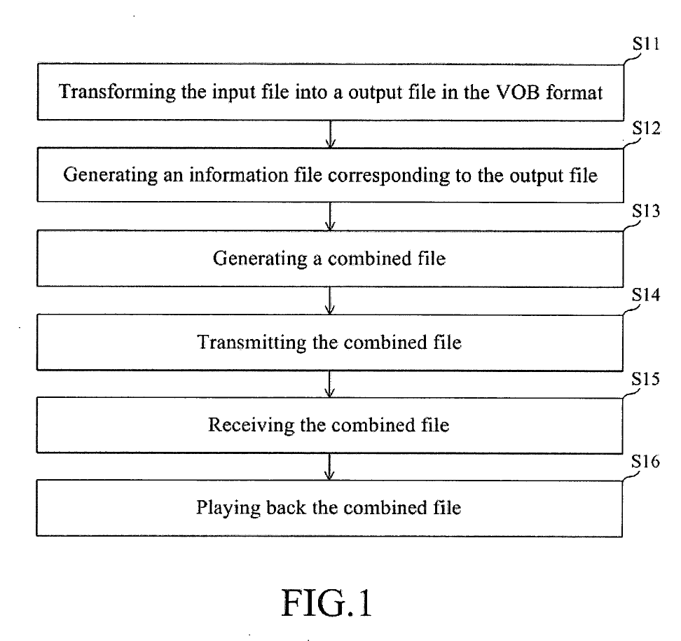

Please refer to FIG. 1. FIG. 1 shows the flowchart of the processing method according to the third preferred embodiment of this invention. In step S11, an input file is transformed into an output file in the VOB format. Step S12 is generating an information file corresponding to the output file. Step S13 is combining the output file with the information file to generate a combined file. Step S14 is transmitting the combined file. Step S15 is receiving the combined file and step S16 is playing back the combined file.

In actual applications, if the input file includes video sections and audio sections, the outputted .VOB file can be generated by synthesizing the video sections and the audio sections. If the input file is an audio file, the outputted .VOB file can be generated by matching up the audio file with at least one pre-provided images. If the input file includes a plurality of pictures, the outputted .VOB file can be generated by matching up the pictures with a presentation script which provides displaying time and displaying intervals for the pictures.

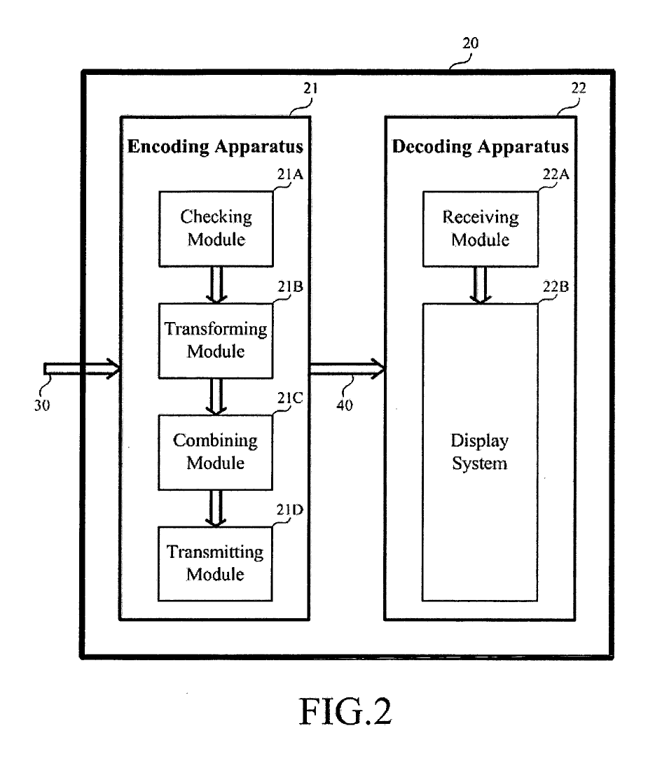

Please refer to FIG. 2. FIG. 2 shows the block diagram of the processing system according to the fourth preferred embodiment of this invention. The processing system 20 includes an encoding apparatus 21 and a decoding apparatus 22.

The encoding apparatus 21 includes a checking module 21A, a transforming module 21B, a combining module 21C, and a transmitting module 21D. The checking module is used for checking whether the input file 30 is in a VOB format. The transforming module 21B is operated by the checking module 21A. If the checking result of the checking module 21A is NO, the transforming module 21B transforms the input file 30 into an output file in the VOB format. The combining module 21C generates an information file corresponding to the output file and combines the output file with the information file to generate a combined file 40. The transmitting module 21D is used for transmitting the combined file.

The decoding apparatus 22 includes a receiving module 22A and a display system 22B. The receiving module 22A is used for receiving the combined file 40 transmitted by the transmitting module 21D. The display system 22B is capable of decoding and playing back the combined file 40.

The apparatus and method according to this invention first transforms the multimedia files into files conforming to the DVD format at the side of storage systems, and then transmits the transformed file to a display system through wired or wireless networks. Since a file conforming to the DVD format has a clear and convenient displaying menu, it is much easier for users to watch and control the transformed file displayed at display systems; thus, problems in prior arts can be solved.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for processing an input file comprising:
transforming the input file into a output file in a VOB (video object) format;
generating an information file corresponding to the output file;
combining the output file with the information file to generate a combined file; and
transmitting the combined file.

2. The method of claim 1, further comprising:
receiving the combined file; and
playing back the combined file.

3. The method of claim 1, wherein the input file is a video file.

4. The method of claim 4, wherein the format of the video file is .mpeg, .wmv, .asf, or .avi.

5. The method of claim 1, wherein the input file is an audio file.

6. The method of claim 5, wherein the format of the audio file is .wav, .cda, .wma, mid, or .mp3.

7. The method of claim 1, wherein the input file is a picture.

8. The method of claim 7, wherein the format of the picture is .jpeg, .gif, .bmp, .tiff, or .png.

9. The method of claim 1, wherein the output file comprises a plurality of sections and the information file is relative to the positions and relations of each section in the output file.

10. An apparatus for processing an input file comprising:
a transforming module for transforming the input file into a output file in a VOB (video object) format;
a combining module for generating an information file corresponding to the output file and combining the output file with the information file to generate a combined file; and
a transmitting module for transmitting the combined file.

11. The apparatus of claim 10, further comprising:
a receiving module for receiving the combined file; and
a playing back module for playing back the combined file.

12. The apparatus of claim 10, wherein the input file is a video file.

13. The apparatus of claim 10, wherein the input file is an audio file.

14. The apparatus of claim 10, wherein the input file is a picture.

15. The apparatus of claim 10, wherein the output file comprises a plurality of sections and the information file is relative to the positions and relations of each section in the output file.

16. A system for processing an input file comprising:
an encoding apparatus comprising:
a checking module for checking whether the input file is in a VOB (video object) format;
a transforming module operated by the checking module, if the checking result of the checking module is NO, the transforming module transforming the input file into a output file in the VOB format;
a combining module for generating an information file corresponding to the output file and combining the output file with the information file to generate a combined file; and
a transmitting module for transmitting the combined file; and
a decoding apparatus comprising:
a receiving module for receiving the combined file transmitted by the transmitting module;
a display system capable of decoding and playing back the combined file.

17. The system of claim 16, wherein the input file is a video file.

18. The system of claim 16, wherein the input file is an audio file.

19. The system of claim 16, wherein the input file is a picture.

20. The system of claim 16, wherein the output file comprises a plurality of sections and the information file is relative to the positions and relations of each section in the output file.
